(19) United States
(12) Patent Application Publication
(10) Pub. No.: US 2007/0058554 A1
(43) Pub. Date: Mar. 15, 2007

(54) Method of networking systems reliability estimation

(75) Inventor: Saida Benlarbi, Ottawa (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/224,992

(22) Filed: Sep. 14, 2005

(51) Int. Cl. H04J 3/14; H04J 3/16

(52) U.S. Cl. 370/248; 370/469

(57) ABSTRACT

Interconnected networking systems is becoming a challenge in terms of dependability estimation as two main communication technologies co-exist in today's networks: switching and routing. These two technologies have two different and complementary levels of resilience. Switching is focused on sensitivity to delays and connectivity whereas routing is focused on traffic losses and traffic integrity. The main challenge in modeling these systems dependability is to aggregate the complexity and interactions from various layers of network functions and work with a viable model that reflects the resilience behavior from the service provider and the service user standpoints. The method uses a hierarchical approach based on the Markov Chains and RBD modeling techniques to build a multi-layered model of assuring a multi-services networking system meets its reliability targets dictated by a service level agreement. To cope with modeling complexity the multi-layered model is constructed so that each layer reflects the network resilience required level of details.

### FIELD OF THE INVENTION

The invention is directed to communication networks and in particular to a method for estimating reliability of networking systems.

### BACKGROUND OF THE INVENTION

Initially, all telecommunication services were offered via PSTN (Public Switched Telephone Network), over a wired infrastructure. During the late 1980s, with the explosion of data networking services such as frame relay, TDM and Asynchronous Transfer Mode (ATM) were developed and then later large Internet based data networks were constructed in parallel with the existing PSTN infrastructure. Currently, the explosion and increasing services needs is driving the construction of communication network as collection of individual networks connected through various network devices that function as a single large network. The main challenges in implementing the functional internetworking between the converged networks lay in the areas of connectivity, reliability, network management and flexibility. Each area is key in establishing an efficient and effective networking system.

In early 1980's the International Organization for Standardization (ISO) began work on a set of protocols to promote open networking environments that help multi-vendor networking systems communicate with one another using internationally accepted communication protocols. It eventually developed the OSI (Open System Interconnection) reference model.

The OSI reference model is a standard reference model, which enables representation of any converged network into hierarchical layers, each layer being defined by the services it supports and protocols it operates. The role of this model is to provide a logical decomposition of a complex network into smaller, more understandable parts, to provide standard interfaces between network functions (program modules), to provide for symmetry in functions performed at each node in the network logic (each layer performs the same functions as its counterpart in the other nodes of the network), to provide means to predict and control any changes made to the network logic, and to provide a standard language to clarify communication between and among network designers, managers, vendors, and users when discussing network functions.

The OSI reference model describes any networking system by one to seven hierarchical layers (L-1 to L-7) of related functions that are needed at each end of the communication path when a message is send from one party to another in the network. Each layer performs a particular data communication task that provides a service to and for the layer that precedes it. Control is passed from one layer to the next, starting at the highest layer in one station, and proceeding to the bottom layer, then over the physical channel (fiber, wire, air) to the next station, and back up the hierarchy. Any existing network product or program can be described in part by where it fits into this layered structure.

In general, the term protocol stack refers to all layers of a protocol family. A protocol refers to an agreed-upon format for transmitting data between two devices. The protocol determines, among other things, the type of error checking to be used, method of data compression, if any, and how a device indicates that it has finished sending or receiving a message.

Various types of services such as voice, video, data are transmitted through different types of transmission spanning combined networks. They are converted along the way from one format to another, according to the respective types of transmission networks and hierarchical protocols. As the traffic grows in volume, there is a growing need to support differentiated services in networking systems, whereby some traffic streams are given higher priority than others at switches and routers. The implementation of differentiated services allows for improved quality of service (QoS) to be realized for higher priority traffic according to the services routing time and delays requirements.

Each network layer inevitably subjects the transmitted information to factors which affect the quality of service expected by a particular subscriber. Such factors stem not only from the nature of a particular network domain, but from the growing traffic load in the today's communication networks. As the size and utilization of the networking systems evolve, so does the complexity of managing, maintaining, and troubleshooting a malfunction in these systems. The reliability of the services offered by a network provider to the subscribers is essential in a world where networking systems are a key element in intra-entity and inter-entity communications and transactions.

Service providers must utilize interfaces to provide connectivity to their customers (users) who desire a presence on the respective networks. To ensure a desired level of service is met, the customers enter into an agreement termed “service level agreement (SLA)” with one or more service providers. The SLA defines the nature of the type as well as the quality of the service to be provided and the responsibilities of both parties, based on a pricing or a capacity allocation scheme. These schemes may use a flat-rate, per-time, per-service, or per-usage charging, or some other method, whereby the subscriber agrees to transmit traffic within a particular set of parameters, such as mean bit-rate, maximum burst size, etc., and the service provider agrees to provide the requested QoS to the subscriber, as long as the sender's traffic remains within the agreed parameters.

On the other hand, the convergence of the various networking systems types makes it difficult for a comprehensive estimate of the network performance needed for enforcing a certain SLA. In addition, as the SLAs must ensure a variety of service quality levels, any performance and reliability assessment must be personalized for the specific terms of the respective SLA. Currently, there are two basic methods used to evaluate networking system performance/reliability: measurement and modeling. The measurement approach requires estimated from data measured in the lab or from a real-time operating network, and uses statistical inferences techniques, being often time expensive and time consuming. Modeling on the other hand is a cost effective approach that allows estimation of networking systems availability/reliability without having to physically build the network in the lab and run experiments on it.

Nonetheless, modeling the availability/reliability of today converged networking systems is a challenging task given their size, complexity and the intricacy of the various layers of system functionality. In particular, it is not an easy task to show if an end-to-end service path meets the 99.999% availability requirement coined from the well proven PSTN reliability, Nor it is easy to assess if a multi-services network meets the tight voice requirement of 60 ms maximum delay from mouth to ear dictated by the maximum window of a perceivable degradation in voice quality.

The main challenge in modeling a converged networking system is to aggregate the complexity and interactions from various layers of network functions and work with a viable model that reflects the networking system resilience behavior from the service provider and the service user standpoints. Another challenge is related to the layers modeling which requires a different approach in availability/reliability than the conventional existing approaches. For example, for network functions of L-1 and L-2, availability/reliability aspects can be easily separated from performance aspects and hence estimated separately, as these functional levels do not exhibit a graceful degrading behavior. In general, they are either operating or failed. On the other hand, for functions of L-3 and -L4, the network behavior shows most of the time a degrading performance state before it fails completely.

Current reliability analysis methods fail to address these two major challenges so that a correct and accurate estimation of the networking system behavior is difficult to perform. In fact the existing methods are suitable for modeling and estimating a particular network functional level and are difficult to extend to the next level. As a result, it is difficult, if not impossible to accurately enforce a SLA with the currently available models.

The traditional methods rely on either non-space-state or space-state techniques to estimate separately the various layers of network functions resilience effects on reliability and availability behavior of network services. An example of such a method is provided by the paper titled “Availability Models in Practice”, by A. Sathaye, A. Ramani and K. Trivedi, which can be viewed/downloaded at: http://www.mathcs.sjsu.edu/faculty/sathaye/pubs.html. The Sathaye paper applies modeling techniques to networked microprocessors in a computing environment, and describes combining performance and reliability analysis at only one network layer at a time. Consequently, the method proposed in the above-referenced paper does not consider the impact of the performance and availability degradation between various layers of the network (e.g. effects at L-3 are considered without assessing their impact on degradation of L-4 functions).

There is a need to provide a method of assessing the network availability/reliability that takes into account the impact of the interaction between the various layers of network resilience. In addition, such a method must be scalable and flexible to use. Still further, there is a need for a method of assessing the network availability/reliability that takes into account the effect of functional degradation of the network performance based on both performance and reliability.

### SUMMARY OF THE INVENTION

It is an object of the invention to provide a method for estimating the reliability/availability of a networking system with a view to enable enforcement of the terms of a respective SLA.

It is another object of the invention to provide a method for estimating the reliability/availability of a networking system that provides a combined performance and reliability measure at different network layers according to the network services employed at each portion of a path under consideration.

Accordingly, the invention provides a method of estimating reliability of communications over a path in a converged networking system supporting a plurality hierarchically layered communication services and protocols, comprising the steps of a) partitioning the path into segments, each segment operating according to a respective network service; b) estimating a reliability parameter for each segment according to a respective OSI layer of the network service corresponding to the segment; c) calculating the path reliability at each the OSI layer as the product of the segments' reliability parameters at that respective layer; and d) integrating the path reliabilities at all the OSI layers to obtain the end-to-end path reliability of communication over the path.

Advantageously, the method of the invention uses an integrated model, reflective of the service reliability. The method according to the invention is based on a layered structure following the OSI reference model and uses powerful and detailed models for each layer involved in the respective path so that aggregate reliability and availability measures can be estimated from each network resilience layer with the appropriate modeling technique.

Another advantage of the invention is that it combines state-space and non-state-space techniques for enabling the service providers to take adequate action for maintaining the estimated aggregate reliability measures close to the measures agreed-upon in the respective SLA's and thus better demonstrate and assure the subscribers that the SLA's are meet. This method could have broad applicability in telecom, computing, storage area network, and any other high-reliability applications that need to estimate and prove that the respective system meets tight reliability service level agreements.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates mapping between services, networking infrastructure and functionality;

FIG. 2 shows an example of a hybrid path across a networking system;

FIG. 3a shows an example of a traffic path across a networking system;

FIG. 3 illustrates how the IP path of FIG. 3a is partitioned into segments, according to the invention;

FIG. 4a shows Markov chain modeling on an ATM VC path with n nodes;

FIG. 4b shows Markov chain modeling on an ATM node with a resilience type of behavior;

FIG. 5 illustrates Markov chain modeling for an IP path.

### DETAILED DESCRIPTION

Availability is defined here as the probability that a networking system performs its expected functions within a given period of time. The term reliability is defined here as the probability that a system operates correctly within a given period of time, and dependability refers to the trustworthiness of a system. In this description, the term “reliability parameter” is used for a network operational parameter defining the performance of the networking system vis-à-vis meeting a certain SLA, such as rerouting delays, or resources utilization (e.g. bandwidth utilization). The terms “estimated parameter” and “contractual parameter” are used for designating the value of the respective parameter estimated with the method according to the invention, or the value of the parameter agreed-upon and stated in the SLA. The term “measure” is used for the value of a selected performance parameter.

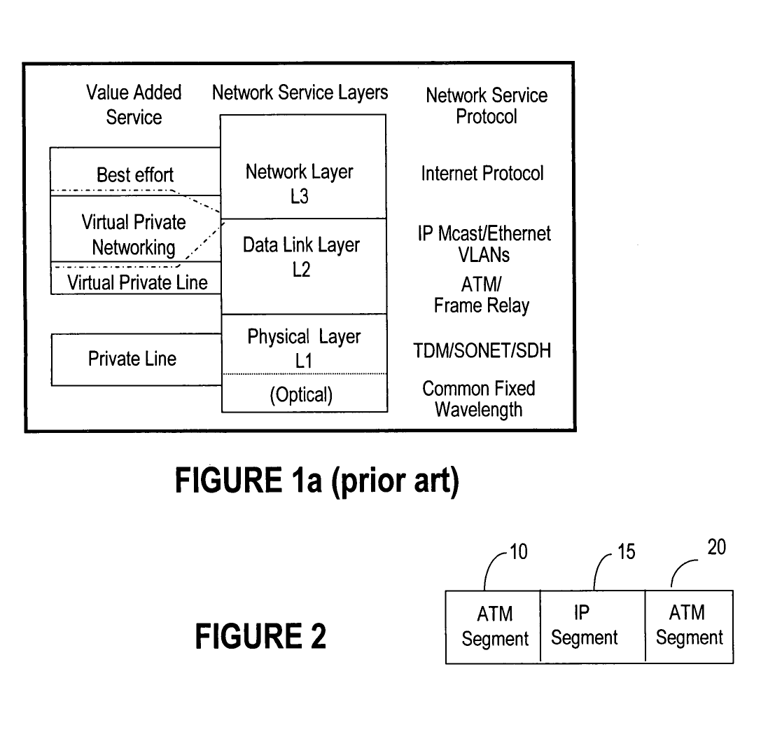

FIG. 1 shows the correspondence between data communication based services, the networking infrastructure that provides it and the networking functionality or service protocol that delivers it, based on the OSI reference model. The higher the layer, the closer to the user. Note that FIG. 1 shows the first three layers only, called the physical layer (L-1), the data link layer (L-2), the network layer (L-3). The transport layer (L-4), the session layer (L-5), the presentation layer (L-6), and the application layer (L-7) are not illustrated for simplicity.

A known most popular transport technology at the Physical Layer (L 1) of data networking systems is SONET/SDH, which is a TDM (time division multiplexing) technology. SONET/SDH provides resilience based on redundant physical paths, such as TDM rings, or linear protection schemes. A new contender, the Resilient Packet Ring (RPR) defined by IEEE 802.17, is a transposition of the TDM rings to the IP packet world. Both categories offer physical protection since when a link is cut or a port is down the traffic still flows through the respective redundant path. On a failure, the TDM technologies enable switchover delays typically less than 50 ms.

At the Link Layer (L-2), technology choices for providing resilience are less diverse. For example, ATM is an L-2 packet-based networking protocol which offers a fixed point-to-point connection known as a “virtual circuit” (VC) between a source and destination. ATM pre-computes backup paths that are activated within a delay in the order of 50 ms to a one second for switched VCs, depending on the number of connections to activate. Ethernet, which is a LAN technology, provides resilience through re-computation of its spanning tree in case of a failure. Because this mechanism is notoriously slow (order of the minute), it has recently been complemented with the Rapid Spanning Tree Protocol, with convergence times of the order of the seconds. Another protocol used at this level is Frame Relay is a packet-switching protocol for connecting devices on a wide area network (WAN) at the first two layers.

At the Network Layer (L-3), the most common protocol option is IP, which conforms to Transmission Control Protocol/Internet Protocol (TCP/IP) standard (L-4). Resilience is provided by the routing protocols which manage failure detection, topology discovery and routing tables updates. Different protocols are used at this layer for packet delivery, depending on where a given system is located in the network and also depending on local preferences: intra-domain protocols such as ISIS, OSPF, EIGRP, or RIP are used within a domain, while inter-domain protocols, such as BGP are used between different domains. Since resilience at L-3 relies on a working routing protocol running at L-4, if the L-4 protocol fails, the routing system has to be removed from the network since it can no longer be active in reconfiguring the network topology to get around the failure and re-establish new routes around it.

As indicated above, the present invention provides a new multi-layered reliability modeling method that integrates sub-models built for different network functional levels with different non-state-space and state-space modeling techniques. The method enables estimation of the effects of the different levels of resilience in a networking system, and enables estimation of networking system services reliability and availability. Referring to FIG. 2, the basic idea of the invention is to partition an end-to-end path over the networking system into segments 10, 15, 20, where each segment operates according to a respective network protocol. In this example, the path has an ATM segment 10, then an IP segment 15 then another ATM segment 20. A reliability parameter is estimated for each segment according to the network layer of the network service corresponding to the segment, namely an L-2 ATM reliability parameter is estimated for each ATM segment, and an L-3/L-4 IP reliability parameter is estimated for the IP segment. Finally, the reliability of the path is calculated as the product of the reliability parameters for all three segments.

In the case where a segment requires a reliability parameter at L-3 or L-4, as is the case for the IP segment 20 of FIG. 2, the estimation of the parameter also takes into account the segment performance. As indicated above, at L-3 or L-4 the path performance can degrade gradually before a complete path failure.

Two modeling approaches are used to evaluate networking systems availability: discrete-event simulation or analytical modeling. The discrete-event simulation model mimics dynamically the detailed system behavior, with a view to evaluate specific measures such as rerouting delays or resources utilization. The analytical model uses a set of mathematical equations to describe the system behavior. The parameters are obtained from solving these equations, for e.g. the system availability, reliability and Mean Time Between Failure (MTBF). The analytical models can be divided in turn into two major classes: non-state space and state space models. Three main assumptions underlie the non-state space modeling techniques: (a) the system is either up or down (no degraded state is captured), (b) the failures are statistically independent and (c) the repairs actions are independent. Two main modeling techniques are used in this category: (i) Reliability Block Diagram (RBD) and (ii) Fault Trees. The RBD technique mimics the logical behavior of failures, whereas the fault tree mimics the logical paths down to one failure. Fault trees are mostly used to isolate catastrophic faults or to perform root cause analysis.

### Models for L-1 Type of Resiliency

RBD (Reliability Block Diagram) is the most used method in the telecom industry to estimate the reliability/availability of the L-1 type segment in a networking system. It is a straightforward means to point out single points of failures. An RBD captures a network function or service as a set of inter-working blocks (e.g. a SONET ring) connected in series and/or in parallel to reflect their operational dependencies. In a series connection, all components are needed for the block to work properly i.e. if any component fails, the function/service also fails. In a parallel connection at least one of the components is needed to work for the block to work.

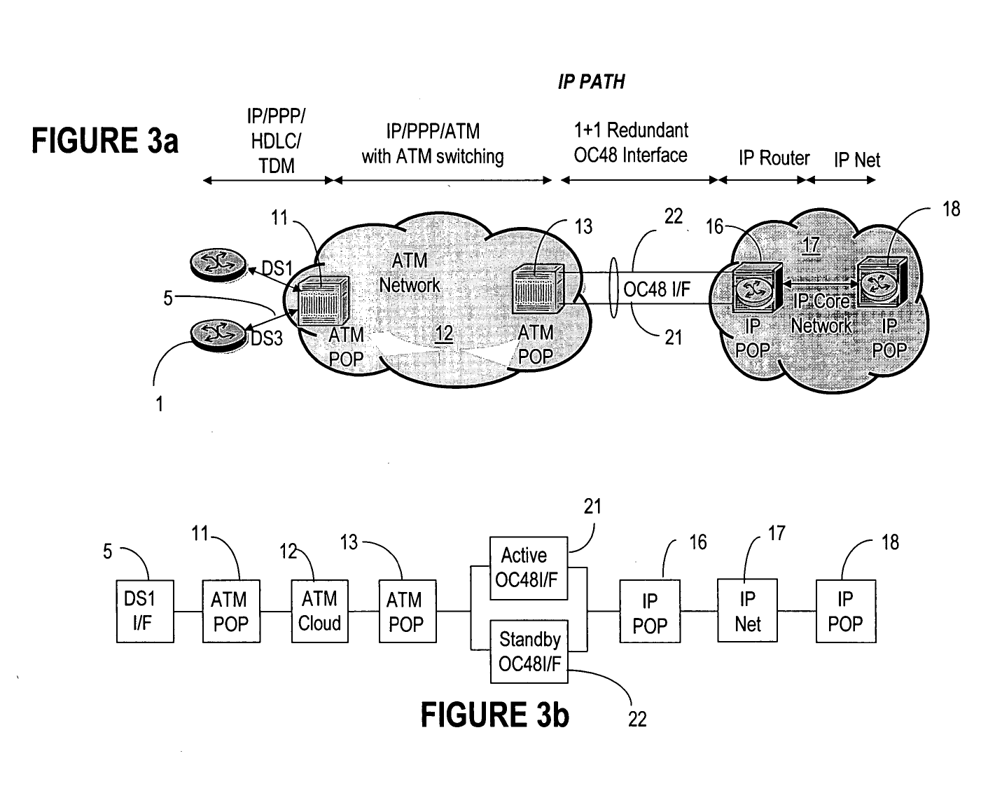

FIG. 3a shows an example of an IP path between a source point 5 (in this example a DS3 interface receiving traffic from a device 1) and end point 18 in this example an IP point of presence (PoP), the path crosses an ATM network 12 and an IP network 17. The ATM network and the IP network are connected through a protected OC48 link 21, 22. FIG. 3b represents the RBD (reliability block diagram) of the path as a succession of blocks in series and in parallel to reflect the level L1 of the network. The term “block” refers to path segments to reflect their respective functional behavior and functional dependencies. As seen in FIG. 3b, the IP path includes the DS1 interface 5, block 11, which is an ATM POP, block 12, which is the ATM network, block 13, which is a second ATM POP, the working and protection OC48 links 21, 22 shown in parallel, block 16, which is an IP POP, block 17, which is the IP network, and block 18 another IP POP.

Given a Mean Time Between Failures MTBF and a Mean Time to Repair MTTR, the steady state availability of a block i is given by:

$${A}_{i} = \frac{{MTBF}_{i}}{{MTBF}_{i} + MTTR} \\ and \\ {A}_{i} = \frac{{λ}_{i}}{{λ}_{i} + μ} \qquad EQ 1$$

Where λᵢ is the failure rate of a block i and μ is the MTTR.

The availability of the IP path is then given by:

$${A}_{path} = {\prod }_{i} {A}_{i} = {A}_{DS 3} {A}_{PoP}^{2} {A}_{ATM\_Net} {A}_{OC 48} {A}_{IP\_PoP}^{2} {A}_{IP\_net} \qquad EQ 2$$

The availability of the OC48 link is estimated as follows, where simplex means non-redundant:
Aₗᵢₙₖ=1−(1−A_{SimplexLink})² EQ3

In EQ2, the terms of the product represent respectively the availability of the DS3 interface (A_{DS3}), the ATM POP 11 (A_{POP}), the ATM network 12 (A_{ATM}_{_{—}}_{Net}), the OC48 interface (A_{OC48), the IP POP 18 (A}_{IP}_{_{—}}_{POP}), and the IP network 17 (A_{IP}_{_{—}}_{Net}) They are calculated using EQ1, based on the λᵢ and μ for the respective blocks.

### Models for L-2 and L-3 Type of Resilience

One of the major drawbacks of the RBD technique is its lack of reflecting detailed resilience behavior that impacts the estimated reliability/availability. In particular, it is hard to account for the effects of the fault coverage of each functional block and for the effect of L-2 and L-3 type of reliability measures such as detection and recovery times and reroute delays. For the example of FIG. 3a and 3b, in order to estimate the availability of the ATM segment 10, a sub-model that is reflective of the ATM nodes resilience and their capability of rerouting the traffic in case of failure needs to be created.

State-space modeling on the other hand, allows tackling complex reliability behavior such as failure/repair dependencies and shared repair facilities. If the state-space is discrete, it is referred to as a stochastic chain. If the time is discrete, the process is said to be discrete, otherwise it is said to be continuous. Two main techniques are used, namely Markov chains and Petri Nets. A Markov chain is a set of interconnected states that represent the various conditions of the modeled system with temporal transitions between states to mimic the availability and unavailability of the system. Petri nets are more elaborate and closer to an intuitive way of representing a behavioral model. It consists of a set of places, transitions, arcs and tokens. A firing event triggers tokens to move from one place to another along arcs through transitions. The underlying reachability graph provides the behavioral model. For in this specification, the Markov chains method is considered and used as described next. The Markov chains method provides a set of linear/non linear equations that need to be solved to obtain the system Reliability/Availability target estimates.

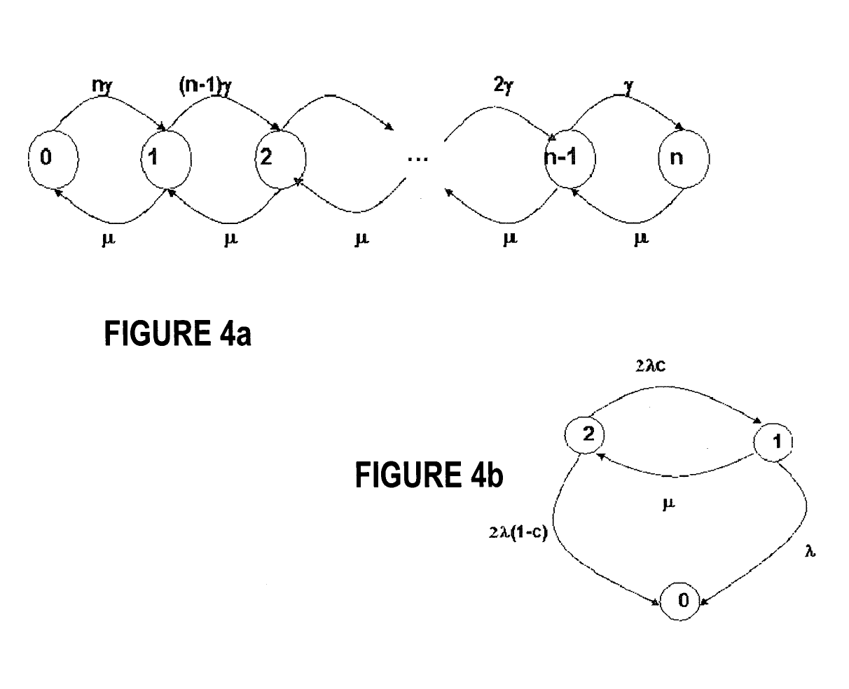

Let's consider the ATM segment 10 of the IP path from FIG. 2. In order to reflect the L-2 resilience and how it gets impacted by the bandwidth available to reroute traffic around failed nodes, we construct a Markov chain that mimics the ATM VC path states, as shown in FIG. 4a. FIG. 4a shows the states of the nodes of the ATM network 12 that carry the ATM path segment. The states are denoted with 0 to n, γ is the ATM node failure rate and μ is the MTTR (Mean time to repair). The ATM VC path is “up” (i.e. caries traffic end-to-end) if at least one of the n ATM nodes is operational. After a node failure, the VC is rerouted if the node available bandwidth allows it. For i=0, 1, . . . , n−1, state i means that the VC path is in an up state and the failed node has enough bandwidth to reroute the path, but k out of n nodes are “down” (i.e. the node fails to switch traffic) because either the respective node is down or it has no available bandwidth to reroute the traffic. State n means that the VC path is completely down i.e. all the ATM nodes spanned by the ATM path are down. The ATM VC path availability is estimated as:
Aₚₐₜₕ=1−Uₚₐₜₕ EQ4
Where Uₚₐₜₕ is the unavailability of the path.

Aₚₐₜₕ is defined as a function of n, which is the number of nodes in the path, and can be computed using the steady state probability πᵢ of each state i that is derived from ρ, which is the node failure rate given by the ratio of failure time to repair time. Aₚₐₜₕ is determined as follows:

$${A}_{path} = 1 - {π}_{n} ; \\ {U}_{path} = {π}_{n} = \frac{{ρ}_{node}^{n}}{{\sum }_{k = 0}^{n} {ρ}_{node}^{k}} \\ where \\ {ρ}_{node} = \frac{γ}{μ} \qquad EQ 5$$

πₙ is obtained from solving the system of n equations where the unknowns are the πᵢ, and from node failure rates γ.

To determine a node failure rate γ we calculate its MTBF (γ=1/MTBF) using another Markov chain that mimics the node behavior and takes into account the probability of reroute given the available bandwidth in the node and the node infrastructure behavior estimated by its failure rate λ. The latter is estimated from the node physical components failure rates. FIG. 4b shows the Markov chain that models the ATM node resilience behavior.

State2 represents the node when up, and a failure is either removed with a probability c of reroute success, or is not removed with a 1-c probability if rerouting cannot be performed because of lack of bandwidth. A fault is removed if it is detected and recovered from without taking down the service. State1 represents the node when up but in simplex mode with no alternative routes. State0 represents the node when down, because e.g. all routes out are failed or no capacity is available on any. The node mean time to failure (MTTF) can be estimated by:

$$MTTF = \frac{λ ( 1 + 2 c ) + μ}{2 λ ( λ + μ ( 1 - c ) )} \qquad EQ 6$$

The model was tried for a network with an SPVC path with an average of 5 to 6 nodes and with an MTTR of <3 hours. It has been demonstrated that 99.999% path availability is reached only if the probability of reroute success is at least 50%, given the way the networking system has been engineered.

The reroute time has been assumed negligible in the ATM path model above. However, if the impact of reroute on the availability is accounted for, as it is the case for an L-3/L-4 type of resilience behavior, a more complex Markov chain needs to be constructed, that details the states when the IP path is in recovery.

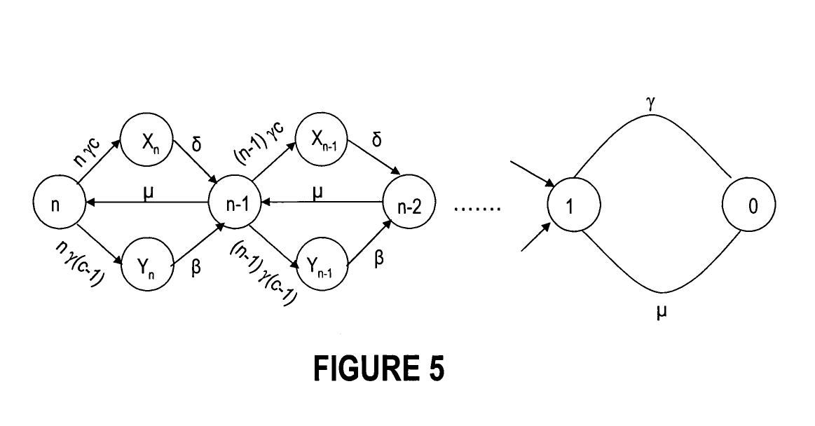

FIG. 5 shows an example of a Markov chain adopted from the above identified article by Sathaye et al. to estimate the IP path availability from PoP 11 to PoP 18. The model according to this invention uses the idea of weighting the states transitions using performance parameters and transforming the weighted states into reliability parameters that are derived either from the functional or performance behavior of the elements (products) that compose the path. The path resilience in FIG. 5 is based on an ACEIS (Alcatel's Carrier Environment Internet System) type of recovery solution. ACEIS is an availability solution that provides for separation of the routing and forwarding engines, and maintains a hot standby routing stack. A hitless switchover of the protocol activities to the standby processing elements is performed when the currently active engine fails. This requires maintaining the synchronization of the computing state between the active routing protocol and the standby one, so that the traffic is switched over graciously. For connectionless protocols such as raw IP or UDP (L-3) where a simple address shift is necessary, the recovery is very rapid. It is more complex for connection-based protocols of L-4 such as TCP, as the state of all IP sessions must be handed over along with the IP address, respecting the ordering and synchronization constraints to avoid a noticeable impact on the service. If the switchover happens in few seconds, the traffic will continue to flow with no noticeable delays to the rest of the nodes in the network besides a possible slight decrease in the throughput.

Let γ be the failure rate of the IP node, and μ the MTTR for the node. As before, a node failure is covered in this case with a probability c and not covered with probability 1-c. The parameter c stands for fault coverage i.e. probability that the node detects and recovers from a fault without taking down the service. After a node detects the fault, the path is up in a degraded mode, or is completely down, until a handover of the active routing engine activities to the standby one is completed. However, after an uncovered fault, the path is down until the failed node is taken out from the path and the network reconfigured with a new routing table re-generated and broadcast to all nodes. The routing engine switchover time and the network reconfiguration time are assumed to be exponentially distributed with means 1/ε and 1/β respectively. The routing engine switchover time is in the order of the second. However, the path reconfiguration time may be in the order of the minutes.

These two parameters are assumed to be small compared to the node MTBF and MTTR hence no failures and repairs are assumed to happen during these actions. The path is up if at least one of its n nodes is operational. The state i, 1≦i≦n, means that node i is operational and n-i nodes are down waiting for repair. The states Xₙ₋ᵢ and Yₙ₋ᵢ(0≦i≦n−2) reflect the path recovery state and the path reconfiguration state respectively. The path availability, denoted with A(n) since now it takes into account the reroute time, is computed as a function of the number of nodes n. In fact, EQ7 below provides the path unavailability computed from the steady state probability πᵢ of each state i as:

$$UA ( n ) = 1 - {\sum }_{i = 1}^{n} {π}_{i} \qquad EQ 7$$

### Multi-Layered Availability Model to Estimate a Networking System

In networking system design, a pure availability model may still not reflect all traffic behavior to account for the impact of dropped traffic or for reroute capability, as it is impacted by the available bandwidth capacity. For e.g. a VPN service availability is dependent on both the infrastructure it is deployed on and the way it is deployed. If the VPN is deployed on a dedicated infrastructure, for example Ethernet switches interconnected by dedicated fiber infrastructure, the availability of the Ethernet VPN service is then relative to the availability of the access infrastructure, of the core infrastructure and of the congestion that the engineered bandwidth allows on the core infrastructure. If pure reliability models are used to estimate the access and core infrastructure availability as the one used in FIG. 5, the impact of various performances levels at various functional/ operational states cannot be shown. In particular, the impact of the network delay and its jitter and the traffic loss on the service availability is not determined. On the other hand, modeling the performance separately from the reliability misses to reflect failure/repair behavior and makes it difficult to demonstrate if an SLA is met under a given engineered bandwidth. Hence, for an L-2/L-3 type of resilience, node performance features need to be combined with node operational behavior to reflect the effects of the network behavior on the service availability.

A key practical issue in network dimensioning for an optimal service availability (that meet tight SLA's) is to estimate the right number of nodes per service path and the optimal load levels of each node that impact its reroute capabilities. This issue could be resolved using performability models such as the ones suggested by the Sathaye et al article. The composite models shown in this paper capture the effect of functional degradation based on both performance and availability. An approach to build such a model is to use a Markov chain augmented with reward rates rᵢ attached to the failure/repair states in the model. Different reward schemes can be devised to account for the impact of performance features on the availability. For example, for the IP path dimensioning, the Markov chain in FIG. 5 can be used, augmented with rᵢ=1 for the down states, and rᵢ=f(pᵢ,qᵢ) where pᵢ is the probability to drop traffic if no bandwidth is available and qᵢ is the recovery time for a path with i operational nodes in the IP path and f is an appropriately chosen function that reflects their relationship. The recovery time can be defined in turn as a function of the network delay and its jitter.

The state-space technique may still suffer from a number of limiting factors. As the modeled block complexity grows, the state space model complexity may grow exponentially. For e.g., in the case of the ATM path model we have used a simplified time discrete Markov chain that does not distinguish between hardware and software failures i.e. assumed the same recovery times. It also assumes a common repair facility for the all the nodes (same MTTR for all the nodes). To cope with service availability modeling complexity a multi-layered model is needed to account for the various layers of resilience in the networking system with the level of details required. The model according to the invention described and illustrated above proposes that the first layer of the model consists in defining an RBD that describes the basic functional blocks of the service i.e. partition the Service path in segments based on the various infrastructure and protocols that supports the Service. In a second step, the service availability of each functional block can be estimated by using either a pure availability model if it is an L-1 or L-2 type of functional block or a composite model that reflects both the availability and performance of an L-2 or L-3/L-4 type of functional block.

Each pure availability model can be in turn constructed using either an RBD or Markov chain techniques depending on the focus of the resilience behavior of the block. The last step of the model is to aggregate the results from the sub-models and compute the resulting Service Availability as a product of the composing block availability. Hence the choice of the modeling technique suitable for a networking resilience level is dictated by the need to account for the impact of the resilience parameters on the availability measure, the level of details of the node/network/service behavior to be represented and the ease of construction and use of the models. Based on this multi-layered modeling approach, one can prove tight SLA's are met under a given infrastructure with a given engineered bandwidth to provide data communication or content or any other value added services.

I claim:

1. A method of estimating reliability of communications over a path in a converged networking system supporting a plurality hierarchically layered communication services and protocols, comprising the steps of:
a) partitioning the path into segments, each segment operating according to a respective network service;
b) estimating a reliability parameter for each segment according to a respective OSI layer of the network service corresponding to the segment;
c) calculating the path reliability at each said OSI layer as the product of the segments' reliability parameters at that respective layer; and
d) integrating the path reliabilities at all said OSI layers to obtain the end-to-end path reliability of communication over said path.

2. The method of claim 1, wherein step b) comprises estimating the reliability of said path at OSI layer L-1.

3. The method of claim 2, wherein step b) comprises:
preparing a reliability block diagram (RBD) for said path as series and parallel connected inter-working blocks, each block capturing a L-1 network function or service;
estimating the availability of each block in said RBD;
estimating the availability of each group of parallel connected blocks in said RBD, to obtain an availability parameter for each said group; and
calculating the availability of said path as a product of availabilities of said series-connected blocks and said availability parameter for each said group.

4. The method of claim 3, wherein the reliability of a SONET link between two blocks is estimated using EQ3.

5. The method of claim 3, wherein the availability of each block in said RBD is calculated using the failure rate and the mean time to repair (MTTR) for said respective block.

6. The method of claim 1, wherein step b) comprises estimating the reliability of said path at OSI layers L-2 to L-4.

7. The method of claim 6, wherein reliability parameters for OSI level L-2 to L-4 includes combined performance and reliability measures.

8. The method of claim 6, wherein step b) comprises, constructing, for each segment of said path that operates at OSI layer L-2 a Markov chain that mimics the states of all nodes of said respective segment.

9. The method of claim 8, wherein each node of said segment assumes a value between 0 and n, where said segment is “up” if at least one of the n nodes of said segment is operational.

10. The method of claim 8, wherein each node of said segment assumes a value between 0 and n, and wherein, upon failure of a node, a state i E [0, n] means that said segment is “up” and the failed node has enough bandwidth to reroute the path, but k out of n nodes are “down” because either said failed node is “down” or has no available bandwidth to reroute the traffic.

11. The method of claim 8, wherein each node of said segment assumes a value between 0 and n, and wherein a state n means that said segment is completely “down” since all nodes spanned by said segment are “down”.

12. The method of claim 8 wherein the availability of said segment is calculated using EQ5 using node failure rates and mean time to repair.

13. The method of claim 12, wherein each node failure rate is determined using a further Markov chain that mimics the behavior of said respective node and takes into account the probability of a reroute estimated based on the available bandwidth in the node and the node infrastructure behavior estimated by its failure rate.

14. The method of claim 6, wherein step b) comprises, constructing, for each segment of said path that operates at OSI layer L-3 and above a Markov chain that mimics the states of all nodes of said respective segment.

15. The method of claim 14, wherein said further Markov chain represents said node in a State2 when “up”, and a failure is removed with a probability c of a reroute success, or is not removed with a 1-c probability, if rerouting cannot be performed because of insufficient bandwidth.

16. The method of claim 15 said reroute success comprises detection of a fault at said node and recovery from said fault without service interruption.

17. The method of claim 14, wherein said further Markov chain represents said node in a State1 when “up” but in simplex mode with no alternative routes.

18. The method of claim 14, wherein said further Markov chain represents said node in a State0 when “down” because all routes out are failed or no capacity is available on any.
